(19) United States
(12) Patent Application Publication
(10) Pub. No.: US 2019/0045768 A1
(43) Pub. Date: Feb. 14, 2019

(54) Fish Measuring Device

(71) Applicant: Ryan C. Rasmussen, San Tan Valley, AZ (US)

(72) Inventor: Ryan C. Rasmussen, San Tan Valley, AZ (US)

(21) Appl. No.: 15/672,244

(22) Filed: Aug. 8, 2017

(51) Int. Cl. A01K 97/00; G01B 3/10

(52) U.S. Cl. CPC A01K 97/00; G01B 3/1082; G01B 3/1084

(57) ABSTRACT

The present invention consists of a device which aids in the estimating of length and or weight of a fish by measuring an area near the base of the tail fin and converting that data into a length and weight estimate based on these known relationships.

### FIELD OF THE INVENTION

The present invention relates generally to equipment and accessories used by anglers in the sport of fishing. More particularly, it relates to measuring tools that are of the type used by anglers to assist them with establishing or estimating the length and or weight of fish.

### BACKGROUND OF THE INVENTION

The length and or weight of a caught fish is very useful information for the angler. This information is used for various purposes, such as ensuring that legal requirements for fish size are met, personal record keeping, general interest, bragging rights, and so forth. There are various methods and equipment used to estimate or determine fish length and weight. Estimating methods range greatly among anglers and include such things as eyeballing or guessing, using one's arm as a comparison to the fish, using measure markings on various objects like fishing rods, landing nets, boats, clothing and even tattoos. Measuring methods also include using a measuring tape or measuring board of various types. Most length measuring methods involve standard units of measurement such as inches or centimeters. Weight scales are also common to determine the fish weight and some anglers are more interested in learning the fish weight. Fish weight measure methods also vary widely with some scales made specifically to function for fish and other more general use scales employed by the angler and still some anglers guess or estimate the weight of the fish using a visual inspection. Units of weight measurement are commonly in pounds or in metric units.

Modern anglers increasingly opt for the release of the caught fish, the idea being that the fish can recover and be recaught at another time. This catch and release practice of fishing tends to look for ways to decrease the trauma inflicted on the fish thereby increasing the likelihood of survival of the released fish. Decreasing the amount of fish handling by the angler and time out of water for the fish are some of the primary practices that are believed to contribute to greater fish survival rates upon release. The values of successful catch and release fishing and the general means of measuring fish are often at odds with one another. Most measuring practices require both more time out of water and increased handling for the fish. Even when the angler intends to keep the fish the measuring process can be an unwanted hindrance because of the time involved and the awkward handling of slippery and uncooperative fish. In both catch and release fishing and catch and keep fishing the practice of measuring fish is often an awkward and troublesome aspect of the sport.

According, what is needed is a fish length and or weight estimating device which is both quick and convenient for the angler while also requiring less fish handling. Such a device could make measuring fish a more enjoyable aspect of the sport.

### SUMMARY OF THE INVENTION

The advantages of the present invention has provided a convenient and fast measuring and or estimating method for the angler while also decreasing angler handling of the fish.

The present invention takes a far different approach to fish measurement. Rather that trying to measure and or weigh the entire fish the present invention focuses on the biological principle that most fish exhibit growth rates in various body parts which are highly correlated to growth in length and or weight. Because these body part relationships exist the relationship can be documented for many fish species and used to create a measuring standard which displays fish length and or weight based on the size of the body part measured. Or in other words because the relationship is known to exist and can be documented the fish length and or weight can be deduced or estimated by measuring a body part such as an area near the tail fin. This is just what the present invention has accomplished. The scale of the present invention is based on the relationship between the area near the base of the tail fin, and fish length and or weight. Once the width of this position is known the fish length and weight can be estimated.

However, fish anatomy can be difficult to handle or measure by hand. Therefore, the present invention is designed in a way to make measuring the width of the area near the base of the tail fin quick and simple for both the angler and the fish.

The rods of the present invention are affixed to a base unit in such a way as to allow the angler to slide the present invention over the tail fin area of the fish with one rod on either side of the tail fin area. As the angler slides the present invention toward the body of the fish the present invention will come to a stop near the base of the tail fin and allow the Angler to measure the width of that area with predetermined markings on the rods of the present invention. The width information is not displayed in terms of actual width but in terms of total fish weight and or length which have been derived from the relationship which exists between this area of the fish and its total length and or weight. All of this is accomplished with generally less fish handling and trauma than most traditional methods.

One device could be useful for a wide range of fish species or the device may need to be changeable and scaled for the appropriate fish species. Various scales can be places on the same rods for different fish species, or rods could be interchangeable or rods could rotate through different scales. There could be many various means of using different scales on the same tool. Examples of fresh and saltwater fish species that the present invention may be useful for might be but are not limited to: Various Trout, Largemouth Bass, Smallmouth Bass, Walleye, Catfish, Pike, Bluegill, Salmon, Mahi-Mahi, Sailfish, Marlin, Wahoo, Tarpon etc.

The foregoing and other features of the present invention will be apparent from the detailed description that follows.

### BRIEF DESCRIPTION OF THE DRAWINGS

FIG. 1 is a perspective view of the present invention.

FIG. 2 is a plan view of the present invention.

FIG. 3 is a side view of the present invention.

FIG. 4 is a front view of the present invention.

FIG. 5 is a view of the present invention being used by an angler in estimating the length and or weight of a fish.

### DETAILED DESCRIPTION OF THE INVENTION

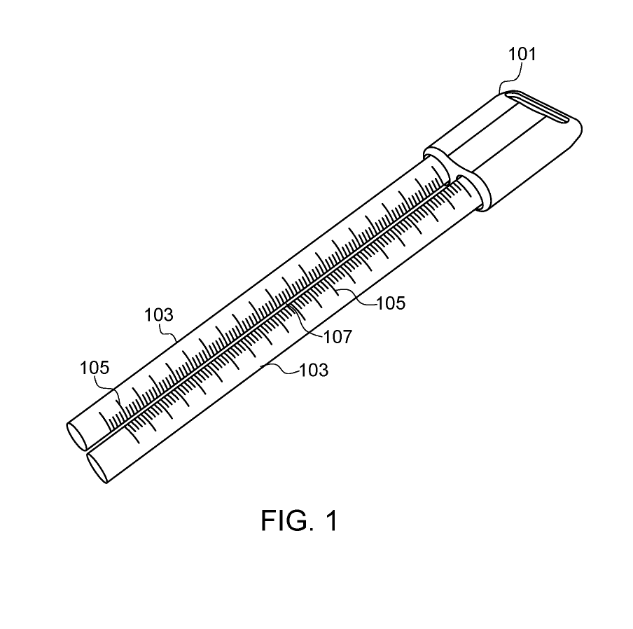

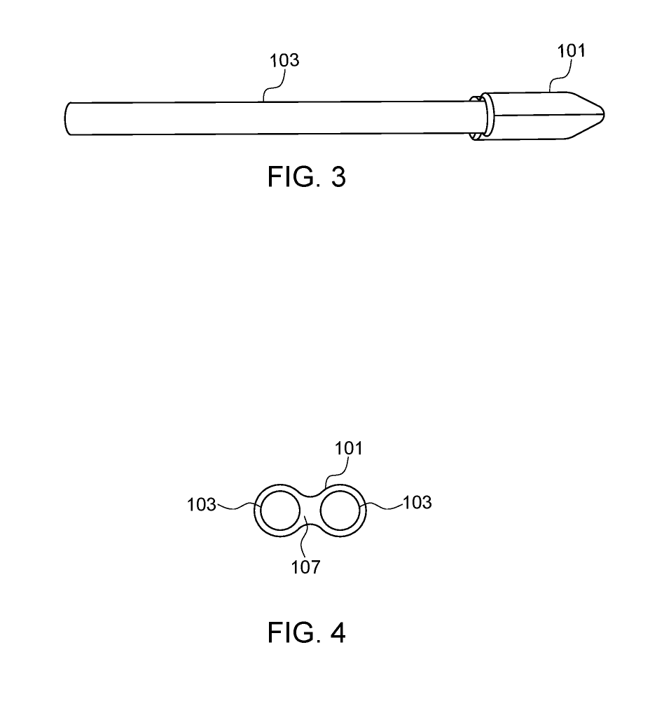

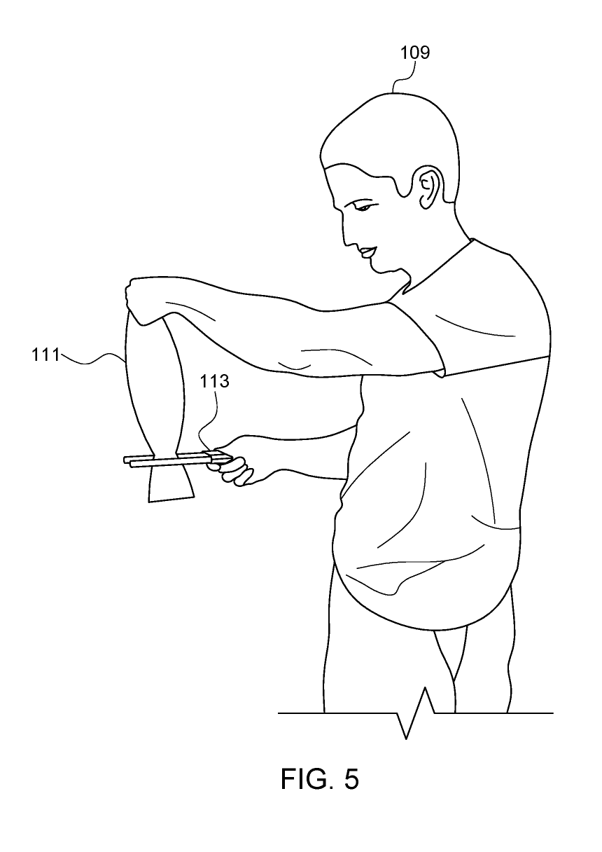

Please refer to FIGS. 1-4. The present invention includes a base 101, rods 103 and a measurement scale 105 associated with the rods 103. In the present invention the rods 103 are parallel to one another and fixed to the base 101 so that there is a uniform gap 107 between the rods 103. The measurement scale(s) 105 is on at least one of the rods 103.

Please refer to FIGS. 1-4. In one embodiment of the present invention the base 101 could be any size of convenience and function and made from a multitude of materials and colors. The base 101 could be made so that it is buoyant and posses one or more connecting points. In the present invention the there are two holes in the base 101 which receive the rods 103 as a means of connection. However this need not be the only means of connecting the rods 103 to the base 101. In fact many connection methods may be advantageous such as clips, locking mechanisms, threads, magnets, pivoting connection points and such. These alternate connection methods would also allow for rods 101 to be interchangeable and or moveable. In one embodiment of the present invention said connection points could also be holes that pass completely through the base 101 so that the rods 103 protrude through both sides of the base 101. Rods 103 that pass all the way through the base 101 could do so for connecting advantages or the rods 103 could pass through in a way as to form another measuring tool on the opposite side of the base 101. Also in one embodiment of the present invention, more than 2 rods 103 could be connected to the base 101 and thus allow more measuring tools on the same base 101. The base 101 could be made to allow one or both rods 103 to rotate and thus reposition one or more measurement scales 105. The base 101 could also be very minimal such as simple fusing of the rods 103 together with gap 107 between. The base 101 could also be shaped in such a way as to allow a more ergonomic holding position.

Please refer to FIG. 1 and FIG. 2 and FIG. 4. The gap 107 between the rods 103 is 1-50 millimeters depending on the fish species and or fish size and or fish age. The gap 107 can be fixed and immovable or adjustable depending on the chosen embodiment of the present invention. The gap 107 is uniform between the rods 103.

Please refer to FIG. 1-5. An angler 109 uses the present invention on a fish 111 by sliding the fish 111 tail area between the rods 103 of the measuring device 113. With the rods 103 of the measuring device 113 on either side of the fish 111 tail fin the angler 109 moves the measuring device 113 toward the body of the fish 111 until the gap 107 between the rods 103 prevents measuring device 113 from moving toward the body of the fish 111 any further. The point of stoppage is generally in the area of the fish 111 near the base of the tail fin where the tail fin and body connect and the tissue of the fish 111 thickens. At this point the angler 109 lines up the markings of the measurement scale 105 with the width of the area the measuring device 113 has stopped on. Because of the relationship which many fish display between various body part sizes and it's length and or weight the angler 109 can estimate fish 111 length and or weight using the width of the area the measuring device 113 has stopped on. To assist the angler 109 in this estimation the measurement scale 105 is calibrated according to the known size relationship between the width of the area the measuring device 113 stopped on and the length and or weight of the fish 111.

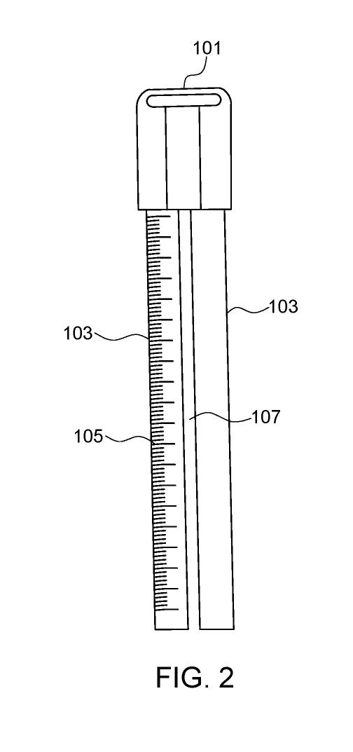

Please refer to FIG. 1-2. The measurement scale 105 of the present invention need not display standard units of measure such as inches or centimeters. Instead the measurement scale 105 will usually display a scale which has been calibrated to display a total fish length and or weight. This calibration can be determined based on the relationship of between the various body parts of the fish and the total fish length and or weight. However in another embodiment of the present invention standard units of measure may be desirable to know the actual width of the base tail fin area of the fish. The measurement scale 105 need not be limited to simple markings on the rods 103 but in another embodiment of the present invention the markings could be digital, changeable and selectable depending on the species of fish being measured. In another embodiment of the present invention a plurality of measurement scales 105 for various fish species could be on one or both rods. The measurement scale 105 could be located on one or all rods 103 and the information on the measurement scale 105 could be identical or different.

Please refer to FIG. 1-5. The rods 103 of the present invention could be of various diameters, shapes and lengths for convenience and function. In the present invention the rods are round. In another embodiment of the present invention the rods 130 may be square, diamond, oval, octagonal, triangle and such. Various rod 103 shapes could offer other advantages such as easier use and or viewing by the angler 109 and or more effective measurement capture on the fish 111. In another embodiment of the present invention the rods 103 need not be of the same shape or size thereby also allowing for more intuitive and or effective use. If one rod 103 were of different size then the angler 109 would be able to quickly identify measuring device 113 orientation or which measurement scale 105 on the measuring device 113 is desired. Differing rod 103 shape and size may also allow for more effective use of the measuring device 113 on the fish 111. The rods 103 can be composed of various materials including but not limited to metal, plastic and composites and constructed in a way in which one or more of the rods 103 of the measuring device 113 will float in water and contribute to or solely maintain total measuring device 113 buoyancy.

The advantages of the present invention and its various embodiments include, without limitation, an effective means of obtaining measurement information from the area in and surrounding the tail fin (caudal fin) of fish including in and surrounding the area of the caudal peduncle of fish. These interests may include but are not limited to finding actual measurement information but also the indirect information that can be derived such as fish length and or weight.

In broad embodiment, the present invention is a means to measure aspects of the caudal fin and or caudal peduncle of the fish and the general place where these areas meet.

While the included written background, summary, description and drawings of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A fish measuring apparatus comprising:
a base member having a plurality of connection points; a plurality of rod members each secured to one of the said connecting points of said base member; and a measurement scale associated with said plurality of rod members.

2. A fish measuring apparatus as in claim 1, further comprising a conversion scale associated with said measurement scale which allows for estimating fish length and or weight information based on the fact that for many fish their body parts grow in close proportion to their total length and weight.

3. A fish measuring apparatus as in claim 1, wherein said plurality of rod members are secured to said base member so that said plurality of rod members are parallel to one another and form a uniform gap between said plurality of rod members and said gap is between 1-50 millimeters.
